(19) United States
(12) Patent Application Publication
(10) Pub. No.: US 2009/0021691 A1
(43) Pub. Date: Jan. 22, 2009

(54) Eyeglasses with an adjustable nose-pad unit

(75) Inventor: Shun-Tien Yang, Yung-Kang City (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: ALL-LOGIC INT. CO., LTD., Yung-Kang City (TW)

(21) Appl. No.: 11/907,342

(22) Filed: Oct. 11, 2007

(30) Foreign Application Priority Data
Jul. 18, 2007 (TW) 096211698

(51) Int. Cl. G02C 5/12

(52) U.S. Cl. 351/137

(57) ABSTRACT

Eyeglasses include: a frame; a pair of pad supports connected to the frame; a nose-pad unit including a pair of pad members, each of which is sleeved rotatably on a respective one of the pad supports; and a pair of positioning units, each of which is coupled to a respective one of the pad supports and a respective one of the pad members, and each of which includes a plurality of first engaging members provided on one of the respective pad support and the respective pad member, and a second engaging member provided on the other of the respective pad support and the respective pad member and engaging releasably a selected one of the first engaging members.

### BACKGROUND OF THE INVENTION

1. Field of the Invention

This invention relates to eyeglasses, more particularly to eyeglasses with an adjustable nose-pad unit.

2. Description of the Related Art

Eyeglasses generally include a pair of nose pads mounted on a pair of supports. Since nose sizes vary among individuals, there is a need for an adjustable nose-pad unit so as to help support eyeglasses at a desired position on a wearer's face, so that eyeglasses can be comfortably worn.

Currently, there are many different types of nose-pad adjustable eyeglasses in the market. For instance, the nose-pads of some conventional glasses can only be adjusted in a left-right direction and are non-removable from a frame body.

### SUMMARY OF THE INVENTION

The object of the present invention is to provide a different design of nose-pad adjustable eyeglasses.

According to the present invention, eyeglasses include: a frame; a pair of pad supports connected to the frame; a nose-pad unit including a pair of pad members, each of which is sleeved rotatably on a respective one of the pad supports; and a pair of positioning units, each of which is coupled to a respective one of the pad supports and a respective one of the pad members, and each of which includes a plurality of first engaging members provided on one of said one of the pad supports and said one of the pad members, and a second engaging member provided on the other of said one of the pad supports and said one of the pad members and engaging releasably a selected one of the first engaging members.

### BRIEF DESCRIPTION OF THE DRAWINGS

In drawings which illustrate an embodiment of the invention,

FIG. 1 is a perspective view of the preferred embodiment of eyeglasses according to the present invention;

FIG. 2 is a fragmentary partly exploded perspective view showing a pair of pad supports and a nose-pad unit;

FIG. 3 is a fragmentary partly exploded top view of the preferred embodiment; and

FIG. 4 is an enlarged sectional view showing how a pad member engages a pad support of the preferred embodiment.

### DETAILED DESCRIPTION OF THE PREFERRED EMBODIMENT

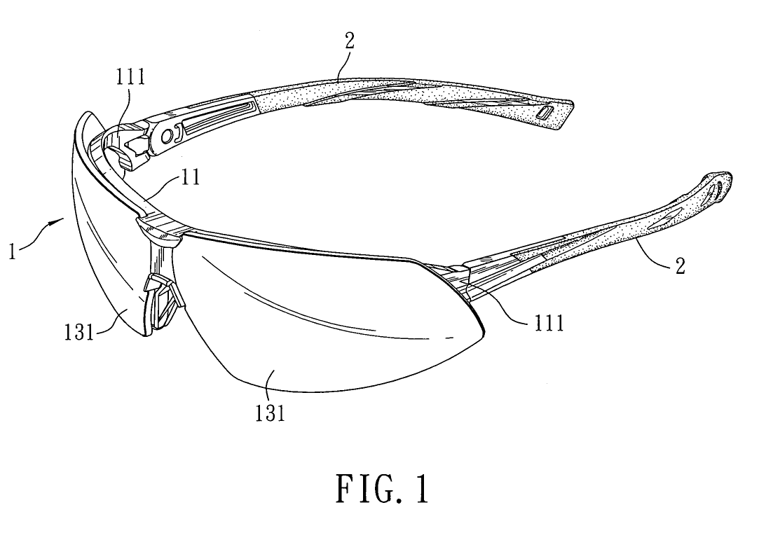

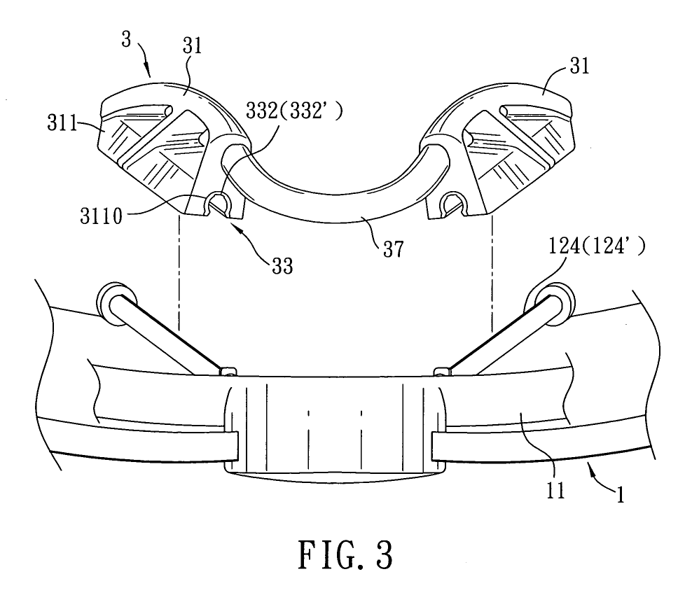

FIGS. 1 to 4 illustrate the preferred embodiment of a pair of eyeglasses 1 according to the present invention.

The eyeglasses 1 include a frame 11; a pair of pad supports 122 connected to the frame 11; a nose-pad unit 3 including a pair of pad members 31, each of which is sleeved rotatably on a respective one of the pad supports 122; and a pair of positioning units 35, each of which is coupled to a respective one of the pad supports 122 and a respective one of the pad members 31, and each of which includes a plurality of first engaging members 332′ provided on one of said one of the pad supports 122 and said one of the pad members 31, and a second engaging member 124′ provided on the other of said one of the pad supports 122 and said one of the pad members 31 and engaging releasably a selected one of the first engaging members 332′. It is to be noted that the frame 11 disclosed herein is not limited to a certain type. Other types of frame 11, such as semi-rimless or rimless frame can also be used in the invention.

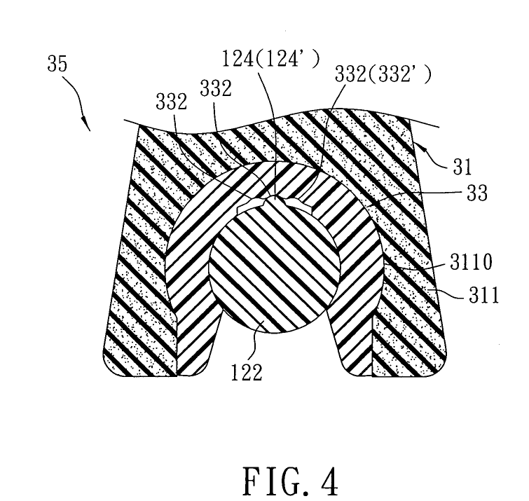

As best shown in FIG. 4, each of the pad members 31 includes an elastic pad body 311 defining a retaining groove 3110, and a rigid sleeve 33 fitted into the retaining groove 3110 and sleeved on a respective one of the pad supports 122. The second engaging member 124′ engages the selected one of the first engaging members 332′ in a tongue-and-groove engaging manner. In this embodiment, the second engaging member 124′ is provided on a corresponding one of the pad supports 122 and is in the form of a protrusion 124 protruding from the corresponding one of the pad supports 122. Each of the first engaging members 332′ is provided on the rigid sleeve 33 of a corresponding one of the pad members 31 and is in the form of a retaining recess 332 formed in the rigid sleeve 33. Each of the pad supports 122 is cylindrical in shape. The rigid sleeve 33 has a C-shape cross section. The retaining recesses 332 are angularly displaced.

Referring back to FIG. 1, the eyeglasses 1 further includes a pair of temples 2 and a pair of lenses 131. Each of the temples 2 is pivotally attached to an outer lateral side of the frame 1 using a hinge 111. The lenses 131 are mounted onto the frame 1. In addition, for each of the pad members 31, the elastic pad body 311 (see FIG. 4) that defines the retaining groove 3110 is fabricated from a soft bendable material such as rubber. The rigid sleeve 33 is made from a rigid plastic material. A bridging rib 37 interconnects the pad members 31 and is made from a flexible material so as to permit independent adjustment of each pad member 31 relative to the respective pad support 122.

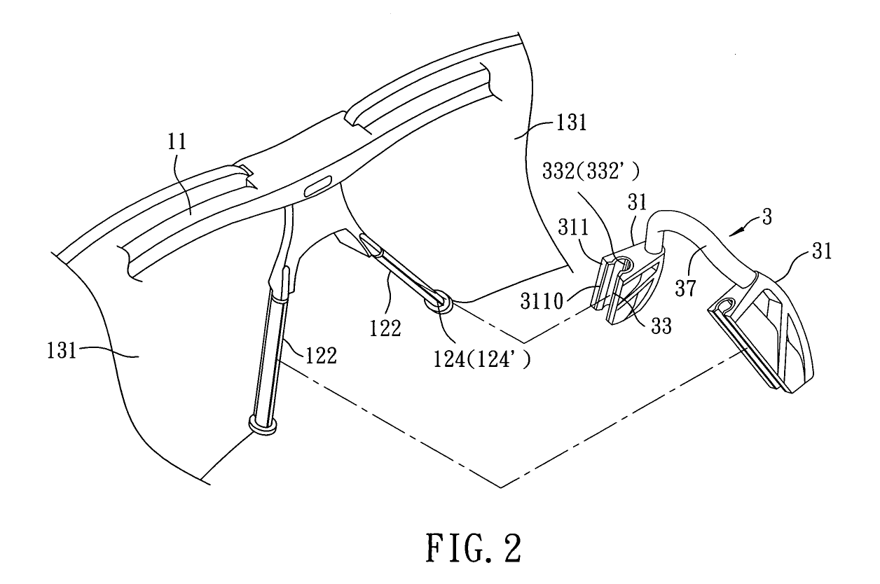

As best shown in FIGS. 2 to 4, when adjusting the angle of the pad member 31, movement of the second engaging member 124′ from a previous first engaging member 332′ to an adjacent first engaging member 332′ results in a noticeable “click” sound, thus providing an indication that the pad member 31 has been adjusted.

In other embodiments of the invention, the second engaging members 124′ of the positioning units 35 can also be provided on the rigid sleeve 33 of the respective pad member 31, whereas the first engaging members 332′ can be provided on the respective pad support 122.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. Eyeglasses comprising:
a frame;
a pair of pad supports connected to said frame;
a nose-pad unit including a pair of pad members, each of which is sleeved rotatably on a respective one of said pad supports; and
a pair of positioning units, each of which is coupled to a respective one of said pad supports and a respective one of said pad members, and each of which includes a plurality of first engaging members provided on one of said one of said pad supports and said one of said pad members, and a second engaging member provided on the other of said one of said pad supports and said one of said pad members and engaging releasably a selected one of said first engaging members.

2. The eyeglasses of claim 1, wherein each of said pad members includes an elastic pad body defining a retaining groove, and a rigid sleeve fitted into said retaining groove and sleeved on a respective one of said pad supports.

3. The eyeglasses of claim 2, wherein said second engaging member engages the selected one of said first engaging members in a tongue-and-groove engaging manner.

4. The eyeglasses of claim 3, wherein said second engaging member is provided on said one of said pad supports and is in the form of a protrusion protruding from said one of said pad supports, each of said first engaging members being provided on said rigid sleeve of said one of said pad members and being in the form of a retaining recess formed in said rigid sleeve.

5. The eyeglasses of claim 4, wherein each of said pad supports is cylindrical in shape.

6. The eyeglasses of claim 5, wherein said rigid sleeve has a C-shape cross section, said retaining recesses being angularly displaced.
